(19) United States
(12) Patent Application Publication
(10) Pub. No.: US 2008/0094224 A1
(43) Pub. Date: Apr. 24, 2008

(54) RFID-ENABLED WASTE/RECYCLING CART

(75) Inventors: Brian G. Parker, Alto, MI (US); P. Charles Ammond, Grand Rapids, MI (US); James R. Kilduff, Sidney, MI (US); Joseph A. Bollo, Hudsonville, MI (US); Michael A. Barrett, Lyons, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: CASCADE ENGINEERING, INC., Grand Rapids, MI (US)

(21) Appl. No.: 11/551,816

(22) Filed: Oct. 23, 2006

(51) Int. Cl. G08B 13/14

(52) U.S. Cl. 340/572.8

(57) ABSTRACT

An RFID-enabled waste/recycling cart including a container, a lid, a hinge pin, and an RFID device. The container includes a handle, and the RFID device is located within the handle. The hinge pin connects the lid to the container and also secures the RFID device within the handle. The RFID device may be attached to or separate from the hinge pin. If attached, the RFID device may be molded to the hinge pin or snap-fitted to the hinge pin. At least one of the handle, the RFID device, and the hinge pin may include structure for angularly orienting the RFID device within the handle.

### BACKGROUND OF THE INVENTION

The present invention generally relates to waste and recycling carts, and more particularly to such carts that are RFID-enabled.

Waste and recycling carts have become the norm for the collection of consumer waste and recyclables. Such carts include a container having an integral handle. A lid is hingedly mounted on the handle to removably cover the container. Wheels support the container for rolling movement. The carts can be stored in a relatively hidden location, for example in a garage, during the week and then easily rolled by the consumer to the curb on pick-up day.

Waste and recycling carts are increasingly incorporating radio frequency identification (RFID) devices. The devices enable a waste removal or recycling service to uniquely identify information associated with a particular cart (e.g. customer name, address, or account information) and to use the information accordingly (e.g. recording the weight removed for billing in the case of waste and for rewards in the case of recycling). Presently, the following methods are used for incorporating an RFID device into a cart: riveting an RFID tag onto the refuse container; concealing an RFID tag in a compartment under the rim of the refuse container; adhering an RFID tag to the container wall; and in-molding an RFID tag into the container—typically the container wall.

Riveting the RFID tag has two disadvantages. First, the riveted tag results in a relatively high cost. The tag assembly must be fabricated separately from the container and then the tag must be secured to the container. Second, the exposed riveted tag is vulnerable to external forces resulting from cart lifting/dumping mechanisms, misuse, or vandalism.

Concealing the RFID tag in the rim provides increased protected from external forces. However, concealing the RFID tag has three disadvantages. First, the concealed tag results in a relatively high cost. The tag assembly must be fabricated separately from the container and then concealed in the compartment. Second, the concealed compartment must be molded into the refuse container, and a separate cover must be molded to cover the compartment. Third, the concealed RFID tag is subject to vandalism by removing the compartment cover (i.e., unscrewing the cover or popping it out of place with a screw driver or other device).

Adhering the RFID tag to the cart or container enables an RFID tag of mid-level cost. This method, however, has two disadvantages. First, additional labor is required. The molded container preferably is flame treated or corona treated before the label is adhered. And a backing must be removed from the pressure-sensitive label, and the label must be carefully applied to minimize crookedness, bubbles, and/or damage to the RFID device. Second, pressure-sensitive adhesive RFID labels are vulnerable to partial or total release over time resulting from the effects of handling equipment, misuse, or vandalism. Consequently, an adhered RFID label is unlikely to remain adhered for the desired period of time.

In-molding the RFID tag eliminates the need for additional labor steps following molding of the container. However, the temperatures and pressures associated with molding can damage the RFID device. Unfortunately, if the RFID device is unusable, replacement of the tag is difficult, possibly making the entire cart scrap.

### SUMMARY OF THE INVENTION

The aforementioned problems are overcome by the present invention wherein an RFID device is included in the handle of a waste or recycling cart.

In one aspect of the invention, the RFID device is secured within the handle using the hinge pin that connects the lid to the container.

In another aspect of the invention, the handle includes structure that maintains the RFID tag in a generally vertical position or any other desired angular orientation within the handle. The structure might be a specially configured cavity. The cavity might define keyways or grooves for receiving the RFID device.

In another aspect of the invention, the RFID tag is attached directly to the hinge pin. For example, the RFID tag could be attached to the hinge pin 1) by insert-molding an RFID tag into the hinge pin, 2) by insert-molding the edge of an RFID tag to the hinge pin or 3) by snap-fitting the RFID tag onto the pin.

Locating the RFID tag within the container handle protects the tag from handling equipment, damage, and vandalism. Because the tag is well protected, an RFID tag of relatively low cost may be used. The hinge pin secures the RFID device in position and prevents its inadvertent removal. Incorporation of the RFID device into the pin facilitates installation, making installation essentially “automatic.” Locating the tag in the handle also enables existing carts to be retrofitted and/or for nonfunctional tags to be swapped out.

These and other objects, advantages, and features of the invention will be more fully understood and appreciated by reference to the description of the current embodiment and the drawings.

### BRIEF DESCRIPTION OF THE DRAWINGS

FIG. 1 is an partially exploded perspective view of a waste container embodying the invention;

FIG. 2 is a perspective view of the area within line 2 in FIG. 1;

FIG. 3 is a cross-section view taken along line 3-3 in FIG. 4;

FIG. 4 is a fragmentary side view of the handle according to a first embodiment of the invention;

FIG. 5 is a cross-section view taken along line 5-5 in FIG. 6;

FIG. 6 is a fragmentary side view of the handle according to a second embodiment of the invention;

FIG. 7 is a cross-section view taken along line 7-7 in FIG. 8;

FIG. 8 is a fragmentary side view of the handle according to a third embodiment of the invention;

FIG. 9 is a side view of a hinge pin including an RFID tag according to a fourth embodiment of the invention;

FIG. 10 is a side view of a hinge pin including an RFID tag according to a fifth embodiment of the invention; and

FIG. 11 is a perspective view of the area within line 2 in FIG. 1 according to a sixth embodiment of the invention.

### DESCRIPTION OF THE CURRENT EMBODIMENTS

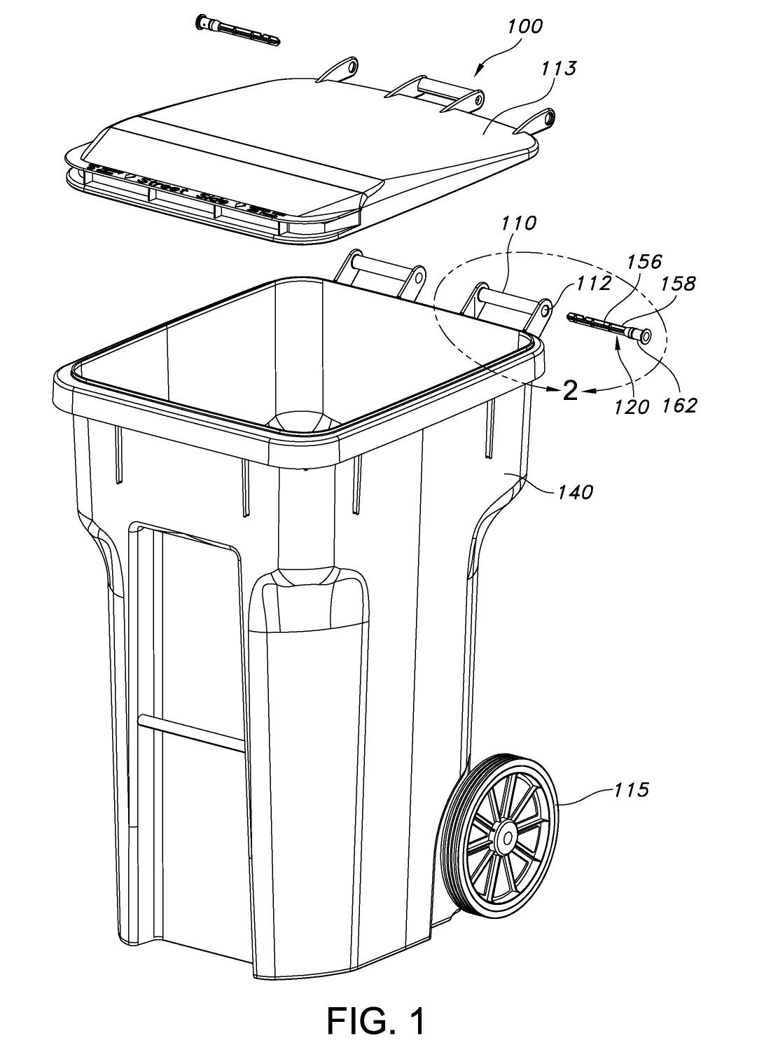

A waste or recycling cart is illustrated in FIG. 1 and designated 100. The cart includes a container 140, a lid 113, wheels 115, a hinge pin 120, and an RFID device or tag 150. With the exception of the specifics of the handle (to be described), the container 140, the lid 113, and the wheels 115 all are components generally well known to those skilled in the art. In the current embodiment, the container 140 and the lid 113 are injection molded plastic, but any other sutiable material of manufacturing method also may be used. The wheels 115 are mounted on an axle (not visible) to enable the cart to be rolled about. A detailed description of these components is unnecessary.

### First Embodiment

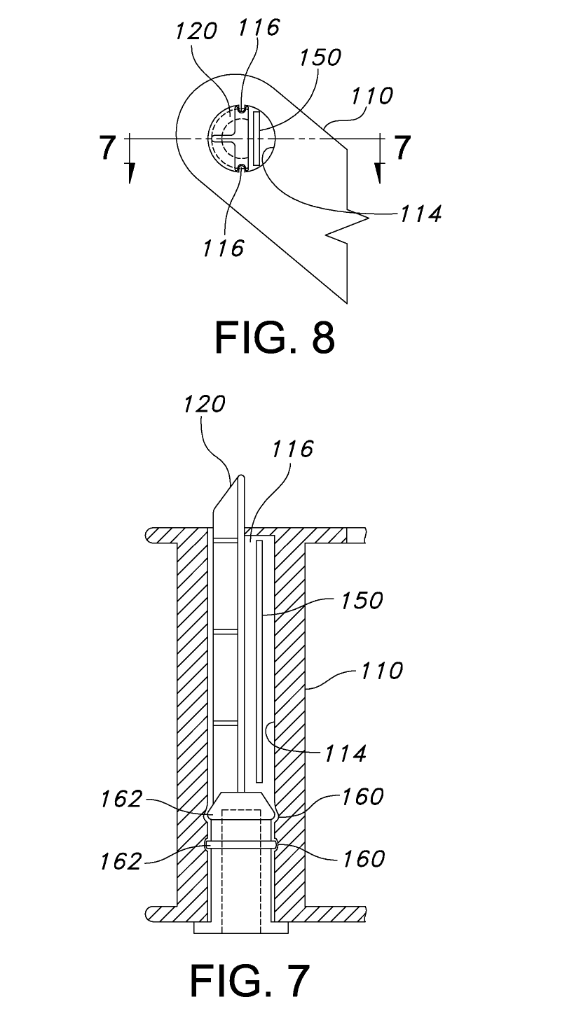

FIGS. 7-8 illustrate a first current embodiment of the invention. The RFID device or tag 150 is located within the cavity 112. The RFID tag 150 can be any appropriate device known to those skilled in the RFID field. In the current embodiments, the RFID tag 150 is a passive device and includes a substrate, an antenna printed on the substrate, and an RFID chip secured to the substrate and electrically connected to the antenna. The tag may be mounted on or molded into the pin 120 or a separate carrier.

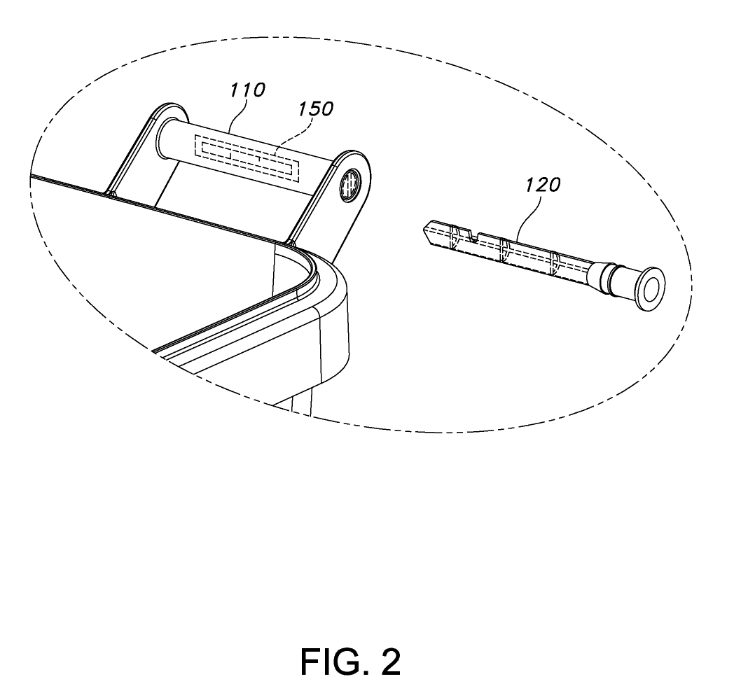

The container 140 includes an integrally molded handle 110 (FIGS. 1-2 and 7-8). The handle 110 defines a cavity 112 surrounded by an interior surface 114. The cavity 112 may extend virtually any length along the handle 110.

The surface 114 defining the cavity 112 includes longitudinal ribs or splines 116. The ribs 116 are located opposite one another and are displaced horizontally off the center of the cavity 112. The ribs 116 define a sub-cavity within the cavity 112 in which only the hinge pin 120 fits. The ribs 116 support the RFID tag 150 in a generally vertical position and maintain the RFID tag 150 at a specific angular orientation within the handle 110. The surface 114 also defines a pair of annular grooves or rings 160.

The hinge pin 120 is an integrally molded article fabricated by injection molding or any other suitable manufacturing method. The pin includes one longitudinal support rib 156 and one or more lateral support ribs 158. The position of the longitudinal support rib 156 and the placement of the lateral support ribs 158 allow the hinge pin to be inserted into the cavity 112 adjacent the RFID tag 150 and between the ribs 116.

The lid 114 is hingedly attached to the handle 110 by the hinge pins 120. Each hinge pin 120 is locked in its secured position by first inserting the hinge pin 120 through a hole in the lid 113 and into the cavity 112. The hinge pin is locked in position by the male mating annular rings 162 seating in the annular grooves 160 of the surface 114. The hinge pin 120 is removable from its installed position only using a special tool (not shown but know to those skilled in the waste cart art). When locked in its secured position, the hinge pin 120 secures the RFID tag 150 within the cavity 112 of the handle 110.

### Second Embodiment

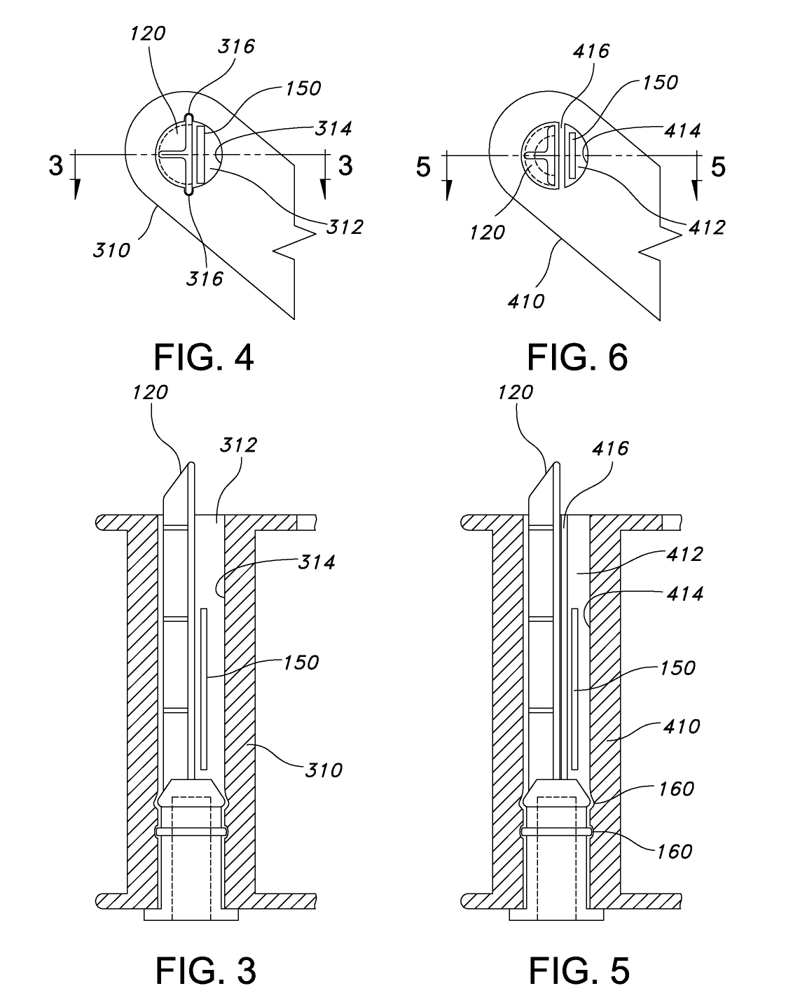

FIGS. 3-4 illustrate a handle 310 of the refuse container 100 according to a second current embodiment of the invention. The interior of the handle 310 defines a cavity 312 having an inner surface 314. The cavity 312 extends the fully length of the handle 310, but may extend along a portion of the handle. The surface 314 includes longitudinal grooves 316, which act as splines, and an annular groove 160. Currently, the grooves 316 are located opposite one another across the cavity 312.

The RFID tag 150 interfits with the grooves 316 to retain the RFID tag in a desired angular orientation, such as the generally vertical orientation illustrated. The grooves 116 and the RFID tag 150 together define a sub-cavity within the cavity 312 to receive the hinge pin 120.

The hinge pin 120 of handle 310 includes a longitudinal support rib 156, a lateral support rib 158, and a male annular ring 162. The hinge pin 120 is locked in its secured position in the same manner as in the first embodiment.

### Third Embodiment

FIGS. 5-6 illustrate a handle 410 of the refuse container 100 according to a third current embodiment of the invention. The handle 410 defines a cavity 412 including an interior surface 414. The cavity 412 includes an integral vertically oriented divider wall 416, which extends the full length of the handle, but could extend only a portion therefor. The interior wall 414 also defines an annular groove 160.

The wall 416 supports the RFID tag 150 in a desired angular oritentation, such as the generally vertical position illustrated. The wall 416 defines two sub-cavities within the cavity 412—one for receiving the RFID tag 150 and another for receiving the hinge pin 120.

The hinge pin 120 is locked in its secured position in the same manner as discussed with regard to FIGS. 1, 2, 7, and 8 above. When locked in its installed position, the hinge pin 120 retains the RFID tag 150 within the cavity 412.

### Fourth Embodiment

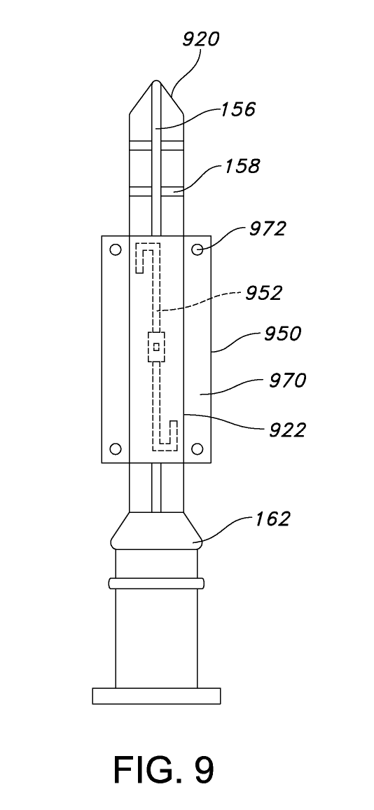

FIG. 9 illustrates a hinge pin 920 according to a fourth current embodiment of the invention. The hinge pin 920 includes parting lines 922, a longitudinal support rib 156, a lateral support rib 158, an annular ring 162, and an RFID tag 950. The RFID tag 950 includes an RFID chip or device 952, a winged portion 970, and a pin hole 972.

The RFID tag 950 is attached or coupled to the hinge pin 920. Preferably, the RFID tag 950 is insert molded into the hinge pin 920 (“in-molded”). In-molding is commonly understood in the industry as the inclusion of additional components to a part during the plastic injection molding process that creates the part. Optionally, the RFID tag 950 can include a protective case to enhance survivability of the tag in the in-molding process. The protective case in the current embodiment is a laminate coating covering the RFID tag 950. Other options for protecting the RFID tag 950 include encapsulation in a plastic case, compression molding, injection molding, and/or hot plate welding. The protective case preferably defines two winged portions 970 that each extend beyond the width of the hinge pin 952 in opposite lateral directions. When the RFID tag 950 is placed in a mold that defines the hinge pin 920, the winged portions 970 overlap that portion of the mold that defines the parting lines 922. Other options for the placing the protective case inside the mold include legs, stand-offs, holes and/or special shapes.

In operation, the winged portion 970 allows a user to clamp up and hold in place the RFID tag 950 during the in-molding process. Alternatively, the pin hole 972, allows a user to employ a mold that includes pins adapted to fit through the pin hole 972. The placement of the pins through the pin hole 972 retains the RFID tag 950 in place during the in-molding process.

### Fifth Embodiment

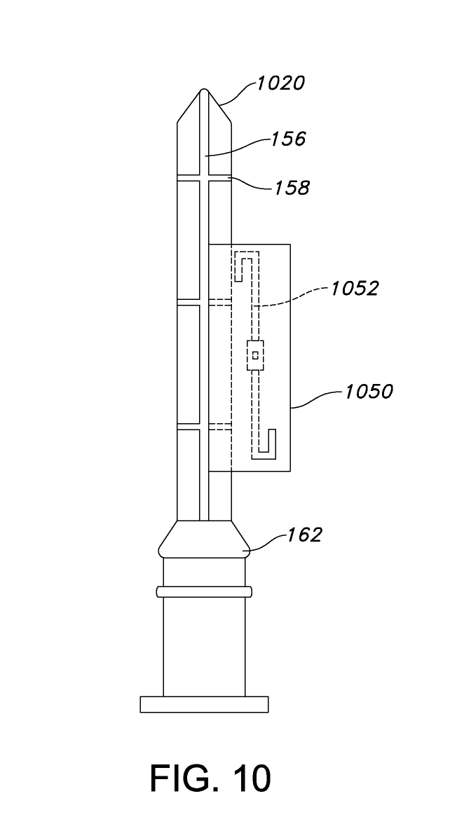

FIG. 10 illustrates a hinge pin 1020 of the refuse container 100 according to a fifth current embodiment of the invention. The hinge pin 1020 includes a longitudinal support rib 156, a lateral support rib 158, a male annular ring 162, and an RFID tag 1050. The RFID tag 1050 includes an RFID chip or device 1052.

A first long-edge of an RFID tag 1050 is in-molded into the center of the hinge pin 920. In this embodiment, the remainder of the RFID tag and a second long-edge of the RFID 1050 extend outward from the hinge pin 1020. Preferably the RFID chip 1052 is located off the first long-edge of the RFID tag 1050, which is in-molded into the center of the hinge pin 1020.

### Sixth Embodiment

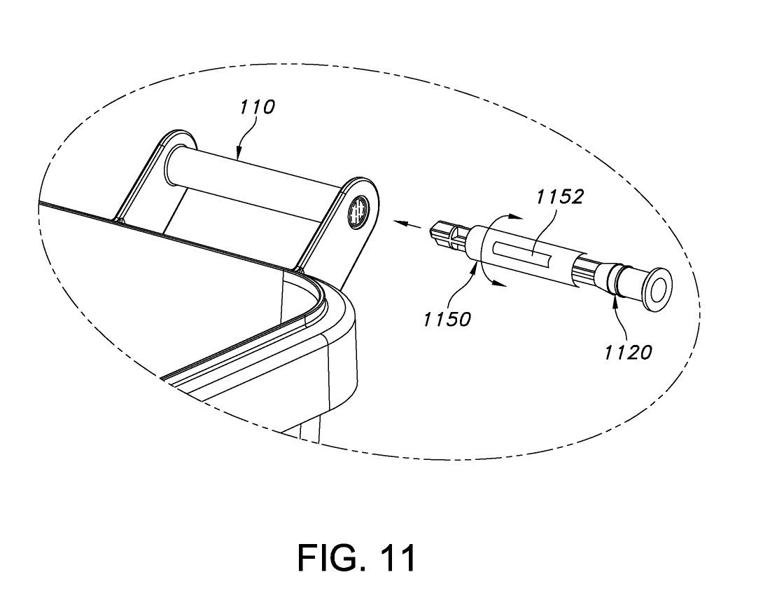

FIG. 11 illustrates a hinge pin 1120 and RFID tag 1150 according to a sixth current embodiment of the invention. The hinge pin 1120 and the RFID tag 1150 are separate independent elements. The RFID tag 1150 includes an RFID chip or device 1152. In this embodiment, the RFID tag 1150 is wrapped around the hinge pin 1120 before both elements are inserted into the cart handle 110. This embodiment enables the pin and the tag to be manufactured separately while still providing the essential functionality of the other embodiments.

### Alternative Embodiments

In alternative (but not illustrated) embodiments, the RFID tag could snap-fit onto the hinge pin. Other methods of attaching the RFID tag to the hinge pin include heat-staking the RFID tag to the hinge pin, welding the RFID tag to the hinge pin, or any other suitable technique known to those skilled in the art.

The above descriptions are those of the current embodiments of the invention. Various alterations and changes can be made without departing from the spirit and broader aspects of the invention as defined in the appended claims, which are to be interpreted in accordance with the principles of patent law including the doctrine of equivalents. Any reference claim elements in the singular, for example, using the articles “a,” “an,” “the” or “said,” is not to be construed as limiting the element to the singular.

The embodiments of the invention in which an exclusive property or privilege is claimed are defined as follows.

1. An RFID-enabled waste/recycling cart comprising:
a container having a handle defining a cavity; and
an RFID device within said cavity.

2. The cart of claim 1 wherein said cavity includes orientation means for orienting said RFID device within said cavity.

3. The cart of claim 2 wherein:
said orientation means includes at least one longitudinal spline; and
said RFID device interfits with said spline.

4. The cart of claim 1 further comprising:
a lid;
a hinge pin in said cavity and hingedly connecting said lid to said container; and
a wall dividing said cavity into a first sub-cavity for said RFID device and a second sub cavity for said hinge pin.

5. The cart of claim 1 further comprising:
a lid; and
a hinge pin in said cavity and connecting said lid to said container.

6. The cart of claim 5 wherein said RFID device is connected to said hinge pin.

7. The cart of claim 6 wherein said RFID device includes a winged portion extending laterally from said hinge pin.

8. The cart of claim 6 wherein said RFID device is integrally molded with said hinge pin.

9. The cart of claim 6 wherein said RFID device is snap-fitted to said hinge pin.

10. The cart of claim 5 wherein said RFID device and said hinge pin are unconnected.

11. An RFID-enabled waste/recycling assembly comprising:
a container having a handle;
a lid;
a hinge pin received within said handle and hingedly connecting said lid to said container; and
an RFID device within said handle.

12. The assembly of claim 11 wherein said RFID device is attached to said hinge pin.

13. The assembly of claim 12 wherein said RFID device is integrally molded with said hinge pin.

14. The assembly of claim 12 wherein said RFID device includes a portion extending laterally beyond said hinge pin.

15. The assembly of claim 12 wherein said RFID device is snap-fitted to said hinge pin.

16. The assembly of claim 11 wherein at least one of said handle, said RFID device, and said hinge pin includes means for orienting said RFID device within said cavity.

17. The assembly of claim 11 wherein said RFID device is attached to said hinge pin.

18. A waste/recycling container hinge pin assembly comprising:
a hinge pin; and
an RFID device attached to said hinge pin.

19. The hinge pin assembly of claim 18 wherein said RFID device is integrally molded with said hinge pin.

20. The hinge pin assembly of claim 19 wherein said RFID device includes a portion extending laterally beyond said hinge pin.

21. The hinge pin assembly of claim 18 wherein said RFID device is snap-fitted to said hinge pin.

22. A method of retrofitting a waste/recycling container to provide RFID capability, the container having a lid and a hing pin connecting the lid to the container, said method comprising the steps of:
removing the hinge pin from a cavity; and
inserting a hinge pin and an RFID device into the cavity.

23. The method of claim 22 wherein the RFID device is connected to the hinge pin.

24. The method of claim 22 wherein the RFID device is separate from the hinge pin.
